(19) United States
(12) Patent Application Publication
(10) Pub. No.: US 2024/0413751 A1
(43) Pub. Date: Dec. 12, 2024

(54) SYSTEM AND METHODS FOR FEEDBACK CONTROL IN SWITCHED CONVERTERS

(71) Applicant: Microchip Technology Incorporated, Chandler, AZ (US)

(72) Inventors: Yong Yuenyongsgool, Gilbert, AZ (US); Andreas Reiter, Feldkirchen-Westerham (DE); Stephen Bowling, Chandler, AZ (US)

(73) Assignee: Microchip Technology Incorporated, Chandler, AZ (US)

(21) Appl. No.: 18/737,148

(22) Filed: Jun. 7, 2024

Related U.S. Application Data
(60) Provisional application No. 63/471,862, filed on Jun. 8, 2023.

(51) Int. Cl. H02M 3/158

(52) U.S. Cl. CPC H02M 3/158

(57) ABSTRACT

A device includes a switched power converter with an inductor, the power converter to produce a voltage output based on a pulse-width modulated (PWM) signal, and produce a peak current feedback signal, the peak current feedback signal representative of a peak current through the inductor. The device includes a comparator to generate a PWM control input (PCI) signal based on whether the peak current feedback signal has reached a reference current. The device includes a PWM generation circuit to generate the PWM signal to control switching of the switched power converter based on the PCI signal. The device includes a synchronization circuit to delay a change in the PCI signal.

### RELATED APPLICATION

This application claims priority to U.S. provisional application Ser. No. 63/471,862, filed on Jun. 8, 2023, the disclosure of which is incorporated by reference in its entirety for all purposes.

### FIELD OF THE INVENTION

The present disclosure relates to switched power converters and, more particularly, to system and methods for feedback control in switched converters.

### BACKGROUND

Switched-mode power converters typically include one or more semiconductor switches and energy storage elements, such as inductors or capacitors, and operate by switching the energy storage elements between various circuit configurations at a predetermined switching frequency. In a pulse-width modulated (“PWM”) converter, the output voltage or current of the power converter can be regulated by varying the duty cycle of the control signal that is applied to the switches.

Analog control methods traditionally have been used to provide line and load regulation of switch-mode power converters, such as DC-DC, AC-DC, DC-AC and AC-AC converters. Conventional analog control techniques for switch-mode power converters include voltage-mode and current-mode control.

Voltage mode control is a single-loop control technique that causes the converter output voltage to track a reference voltage. In particular, the output voltage is compared to the reference voltage, and the error signal is used to set a switch duty ratio of the converter. By varying the switch duty ratio, the average voltage across the inductor, and hence the inductor current, are adjusted. This causes the output voltage to follow the reference voltage.

Current mode control, in contrast, is a two-loop control method that includes current and voltage control loops, and causes the inductor current to track a reference current. In the voltage control loop, the error signal between the output voltage and reference voltage is used to generate a reference current. The current loop compares the reference current to the inductor current to control the switch duty ratio. In this way, some aspect (e.g., peak, valley, average, or some other aspect) of the inductor current tracks the reference current, and the output voltage tracks the reference voltage. Peak current mode control may refer to a control mode in which the peak value of the inductor current tracks the reference current.

In a switched power converter, current mode control may be used to regulate the output current by monitoring and controlling the inductor current. Current mode control may be used in various types of power converters, including but not limited to buck converters, boost converters, and buck-boost converters.

Current mode control may rely on proper adjustment of the pulse width based on the correct timing of the voltage feedback signal from an external compensation network to maintain stability. The voltage feedback signal typically transitions in response to a PWM output signal.

However, the time base of the voltage feedback signal may drift away from the time base of the PWM signal, which may cause a race condition between the voltage feedback signal and the PWM signal. This race condition may result in instability in the loop.

Examples of the present disclosure may address one or more of these issues.

### BRIEF DESCRIPTION OF THE FIGURES

FIG. 1 is an illustration of an apparatus for feedback control of a switched converter, according to examples of the present disclosure.

FIGS. 2-4 illustrate timing diagrams of signals in a switched power converter with current mode control when leading edge blanking (LEB) operation is not utilized.

FIG. 5 illustrates a timing diagram of one of various examples of a circuit for control of PWM signals, and may illustrate when LEB operation is utilized, according to examples of the present disclosure.

FIG. 6 illustrates one of various examples of a synchronizer circuit for control of PWM signals, according to examples of the present disclosure.

FIG. 7 illustrates another example of a waveform and synchronizer circuit for control of PWM signals, according to examples of the present disclosure.

FIG. 8 illustrates one of various examples of a timing diagram of PWM signals, according to examples of the present disclosure.

FIG. 9 illustrates another example of a waveform and synchronizer circuit for control of PWM signals, according to embodiments of the present disclosure.

FIG. 10 is an illustration of a device 1000, according to examples of the present disclosure.

FIG. 11 is an illustration of a system 1100, according to examples of the present disclosure.

FIG. 12 is an illustration of an example method 1200 for feedback control in switched converters, according to examples of the present disclosure.

### DETAILED DESCRIPTION

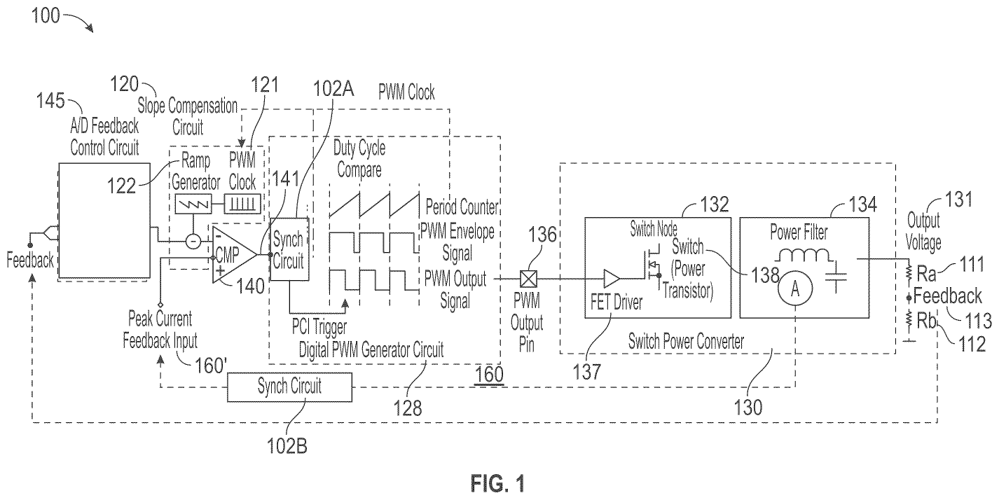

FIG. 1 is an illustration of an apparatus 100 for feedback control of a switched converter, according to examples of the present disclosure. Apparatus 100 may include a switched power converter 130. Apparatus 100 may control switched power converter 130 using current mode control. Switched power converter 130 may be implemented in any suitable manner. Switched power converter 130 may be implemented as a buck converter, a boost converter, a buck-boost converter, or any other suitable type of switched power converter not specifically mentioned. Switched power converter 130 may include a one or more switch nodes 132, which may include any suitable switch 138 or transistor, such as a field effect transistor (FET). Switch 138 may be driven by control signals such as PWM signals, discussed in further detail below. Input control signals to switch 138 may be conditioned by, for example, a FET driver 137. Switch 138 may be connected between a voltage supply and a return, or common, or another high voltage and low voltage, and the output from switch node 132, taken from the high end of switch 138, may be regulated according to the percentage of time that switch 138 is on or off. To further regulate output voltage, switched power converter 130 may include a power filter 134, which may include an inductor connected to a capacitor 142, which in turn may be connected to the return, common or the low voltage.

Switched power converter 130 may produce an output voltage 131. Output voltage 131 may be provided to a first resistor 111 in feedback to a node, such as feedback voltage node 113. Feedback voltage node 113 may be connected between first resistor 111 and a second resistor 112, which second resistor 112 may be connected to the return or ground of the low voltage. Second resistor 112 and first resistor 111 may form a voltage divider. Voltage at feedback voltage node 113 may be generated by the voltage divider formed by first resistor 111 and second resistor 112. Voltage at feedback voltage node 113 may be input to analog or digital feedback control circuit 145.

Analog or digital feedback control circuit 145 may be implemented in any suitable manner to compare feedback voltage against a reference voltage to determine an error. Apparatus 100 may adjust output voltage 131 based on such an error. Analog or digital feedback control circuit 145 may include an error amplifier with a non-inverting input to receive a voltage reference and an inverting input to receive output voltage 131, and may have a feedback network. In other examples, analog or digital feedback control circuit 145 may be implemented by code for execution by or embedded in a processor.

Apparatus 100 may include a slope compensation circuit 120 which may be implemented in any suitable manner. Slope compensation circuit 120 may include a PWM clock circuit 121 and a ramp generation circuit 122. Circuits 121, 122 may be implemented in any suitable manner. Ramp generation circuit 122 may generate a ramp signal based upon an output of PWM clock circuit 121. The output of ramp generation circuit 122 may be input to a subtractor 123 and subtracted by the subtractor 123 from the output of circuit 145. The output of subtractor 123 may be provided to an inverting input of a comparator 140.

Peak current feedback input 160 may be received from switched power converter 130 and provided to a non-inverting input of comparator 140. Peak current feedback input 160 may represent the peak current in an inductor in switched converter 130. Output 141 of comparator 140 may be input to digital PWM generator circuit 128. This output may be referred to as PCI.

Digital PWM generator circuit 128 may be implemented in any suitable manner. Digital PWM generator circuit 128 may generate PWM signals based upon the error determined by analog or digital feedback control circuit 145 and as adjusted by slope compensation circuit 120. Moreover, digital PWM generator circuit 128 may generate PWM signals according to when peak current feedback input 160 passes the reference signal output by analog or digital feedback control circuit 145 and as adjusted by slope compensation circuit 120, as measured by compactor 140.

Digital PWM generator circuit 128 may drive switches in switched converter 130 through PWM output signals provided through pin 136.

In various examples, apparatus 100 may include one or more leading synchronizer 102 circuits that are to maintain a given signal so as to prevent possible race conditions between feedback 113, feedback 160, and generation of new PWM signals. Such a given signal may include peak current feedback input 160 or output of comparator 140.

In one example, a synchronizer circuit 102A may condition or hold output 141 such that a detected change in peak current feedback input 160 is not provided to PWM generation inside of circuit 128 as a PCI trigger until a timing window has passed.

In another example, a synchronizer circuit 102b may condition or hold peak current feedback input 160 itself and a change therein is not provided to comparator 140 until a timing window has passed.

Synchronizer circuits 102a or 102b may be implemented in any suitable manner, such as by a latch, flip-flop, delay, or other suitable circuitry. Synchronizer circuits 102a or 102b may be implemented as an option on an existing circuit. For example, synchronizer circuits 102a or 102b may be implemented as an optional feature within a microcontroller, in a PWM generator, or any suitable signal line.

LEB operation of circuits 102 may be optionally enabled or disabled using, for example, a register value or other setting to enable or disable its use in apparatus 100. Moreover, LEB operation may be activated upon any suitable criteria. Such criteria may be designated using, for example, a register value or other setting. The duration of LEB operation may be set using, for example, a register value or other setting. LEB operation may be timed by, for example, a timer to count clock pulses or PWM pulses. LEB operation may be configured to be enabled upon, for example, a rising edge or a falling edge of a PWM signal input.

In a peak current mode control (PCMC) system such as apparatus 100 where the compensation feedback input signal is sourced by an analog component, such as comparator 140, the feedback input signal can transition high even before (instead of in response to) the rising edge of the PWM output. This may cause the PWM generator circuit to produce no pulses resulting in failure of the compensation network.

With the use of an existing blanking signal, such as used in synchronization circuits 102, to avoid a noisy period during the PWM output transitioning high as the start of the feedback acceptance period, compensation network feedback signal 160 is allowed to transition before or after the PWM transition. As a result, the internally generated signal (PCI trigger) transitions after the PWM output transitions high, and then correctly signals PWM generator circuit 128 to clear its PWM output at the desired timestamp, thus allowing the compensation network in feedback control circuit 145 to function properly.

By subjecting an existing blanking signal to a rising edge detection logic in synchronization circuits 102 while the compensation network feedback input signal is used as the qualifier, the resulting internal signal is conditioned to transition after (and in response to) the PWM output has transitioned high. This enables digital PWM generator circuit 128 to transition its PWM output low correctly based on the feedback 160 in order to begin the next feedback cycle.

Example implementations and uses of synchronization circuits 102, as well as race conditions that may occur without use of synchronization circuits 102, are described below.

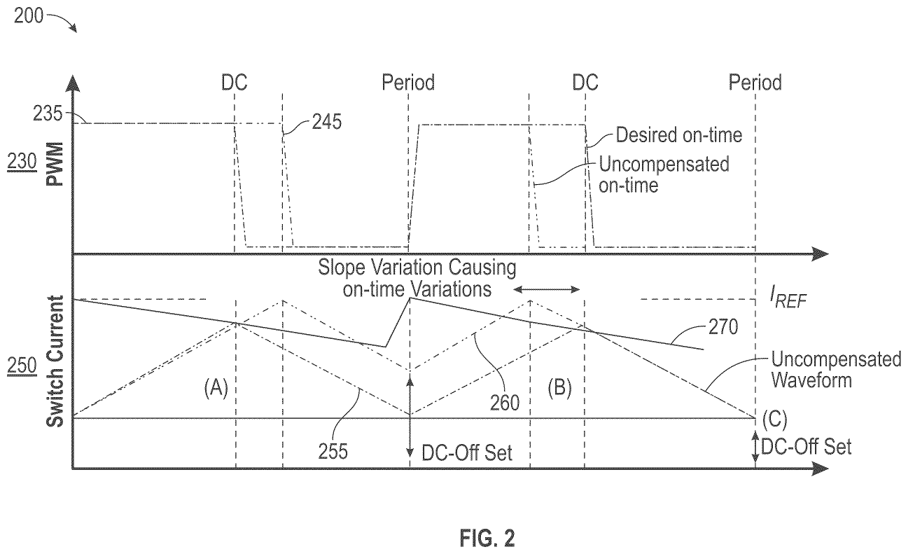

FIG. 2 illustrates a timing diagram 200 of one of various examples of signals in a switched power converter with current mode control, such as switched power converter 130, when LEB operation is not utilized.

PWM signal 230 may represent one of various examples of output 141 of comparator 140. Trace 235 may represent a desired on-time for PWM signal 230. Trace 245 may represent the uncompensated on-time for PWM signal 230. Slope compensation circuit 120 may modify PWM signal 230 to compensate for differences between the average inductor current and the sampled inductor current in switched power converter 130.

Switch current 250 may represent the current in a switch in switched power converter 130. Trace 255 may represent the uncompensated current waveform. Trace 260 may represent the desired current waveform. Trace 270 may represent a slope compensation ramp and may modify the uncompensated current waveform of trace 255.

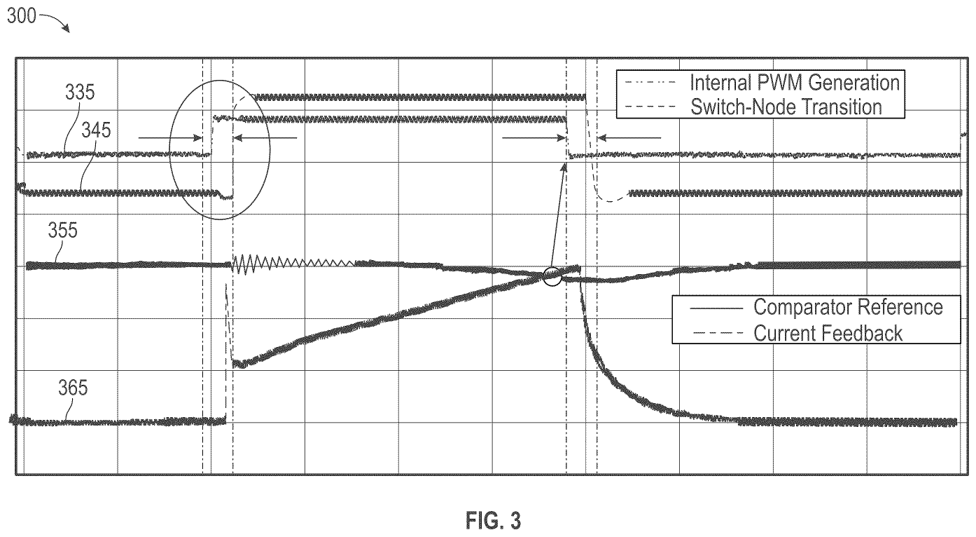

FIG. 3 illustrates a timing diagram 300 of another example of signals in a switched power converter with current mode control when LEB operation is not utilized. Timing diagram 300 illustrates example signal transitions in switched power converter 130. Signals illustrated in FIG. 3 may be generated by a circuit as described in reference to FIG. 1.

Trace 335 illustrates a voltage of a PWM signal. Trace 335 may be generated by PWM generator circuit as described in reference to FIG. 1. Trace 345 illustrates a voltage at a switch node in switched power converter 130. The delay between the low to high transition in trace 335 vs. the low to high transition in trace 345 represents the delay in the signal path between the PWM generation and the switch transition.

Trace 355 illustrates an amplifier output signal. Trace 365 illustrates a current feedback signal. Trace 365 may represent peak current feedback input 160, as described in reference to FIG. 1.

In normal operation, a change in trace 365 such that trace 365 exceeds trace 355 should lag a high to low transition in trace 345. The current feedback should transition after the switch node transition. In some cases, due to excessive delays, a transition in trace 345 may lead a transition in trace 365, as shown, which may introduce instability.

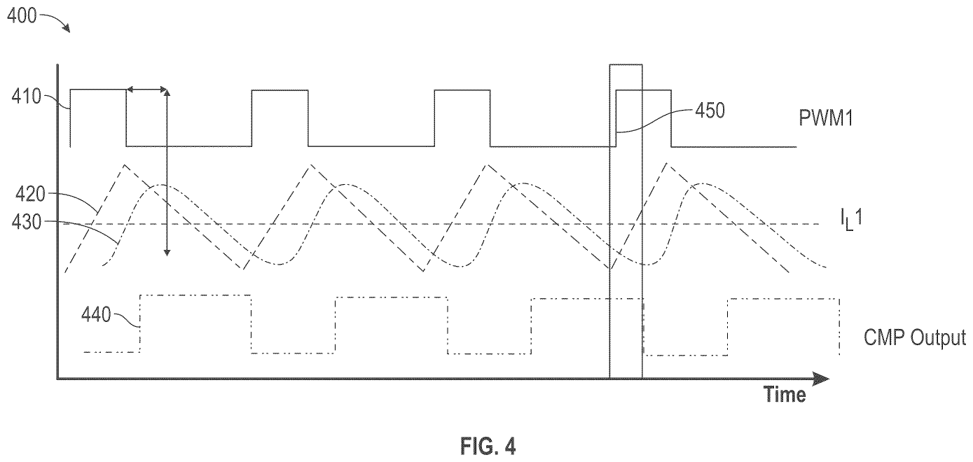

FIG. 4 illustrates a timing diagram 400 of another example of signals in a switched power converter with current mode control when LEB operation is not utilized. Signals illustrated in FIG. 4 may be generated by a circuit as described in reference to FIG. 1.

Trace 410 may represent PWM signal 125, as described and illustrated in reference to FIG. 1. Trace 420 may represent the current through an inductor in switched power converter 130. Trace 430 may represent a filtered inductor current.

Trace 440 may represent the output of comparator 140. In normal operation, there is no overlap between the high time of trace 410 and the high time of trace 440. At time 450, due to excessive delays, there may be an overlap in the high time of trace 410 and trace 440. This may result in instability in the system.

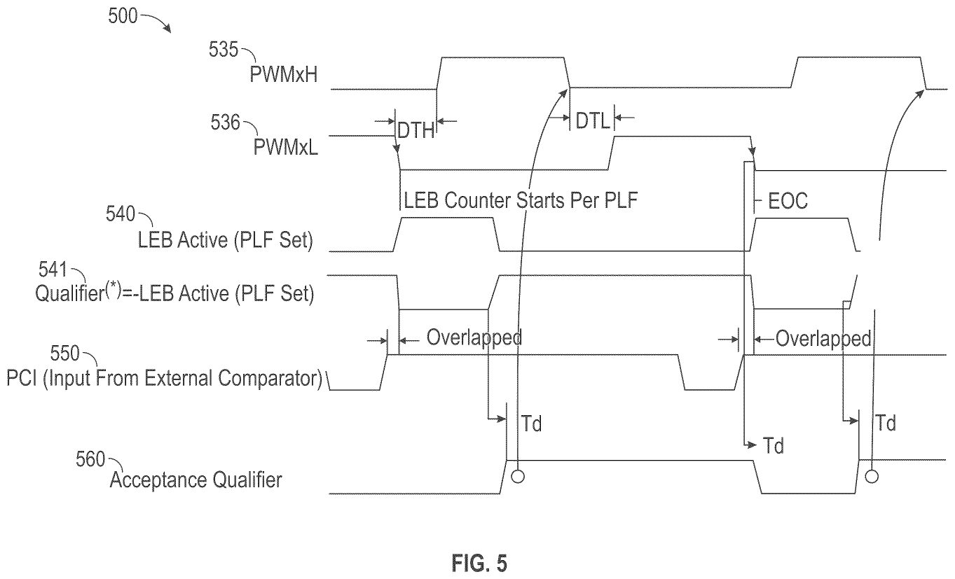

FIG. 5 illustrates a timing diagram 500 of one of various examples of a circuit for control of PWM signals, and may illustrate when LEB operation is utilized. In FIG. 5, comparator output 141 may be used to control a falling edge of PWM pulse output, using blanking time and an acceptance qualifier.

Trace 535 may represent an example PWM signal and trace 536 may represent a corresponding complementary PWM signal. The positive PWM signal may include designated down times (DTH, DTL). The example of FIG. 5 is illustrated with a differential PWM signal wherein, generally, when trace 535 is logic high then trace 536 is logic low, and vice-versa, but this is not intended to be limiting. Trace 540 may represent a LEB signal with a given period, and trace 541 may be an inversion of the LEB signal. Trace 550 may represent a PWM Control Input (PCI). The specific PCI may be a comparator signal or may be another control signal, including but not limited to a register configuration setting. The PCI input represented may be comparator output 141 as described and illustrated in reference to FIG. 1. Trace 560 may be an acceptance qualifier, which may enable compactor output 141 shown in 550 to have an effect on PWM output. A synchronization circuit, such as synchronizer circuit 102, may prevent transitions in trace 550 from affecting the output signal represented by trace 560 while trace 541 is high.

For example, upon a transition from high to low of PWML in trace 536, a LEB period may begin. The LEB period may be tracked by a counter or other suitable mechanism, and a countdown or count may begin. During this period, LEB may be active as shown in trace 540. The resulting PCI input, reflected in trace 550, may have a change whose effect is suppressed during the LEB period. The output shown in trace 560 might not change until an end of the LEB period.

The PWM cycle period may start when trace 536 goes low, and then, after a programmed dead time, DTH trace 535 goes high. At this time, the external PCI control input (comparator output 141) in trace 550 is already high. However, there is no effect because LEB in trace 540 is active and the acceptance qualifier trace 560 is not high yet. After LEB in trace 540 goes low and the acceptance qualifier trace 560 goes high, then and only then can the comparator output 141 shown in trace 550 as PCT have an effect on the PWM output.

In this example, trace 560 goes high after trace 540 goes low, which then directly causes the falling edge on trace 535 for PWMH. PWML automatically goes high after a programmed dead time DTL. Effectively, comparator 140 is controlling the duty cycle of the PWM, but only in a narrow window as defined by the LEB and acceptance qualifier trace 560.

The PWM timebase cycle ends at EOC, which in this example also retriggers the LEB and clears the acceptance qualifier signal.

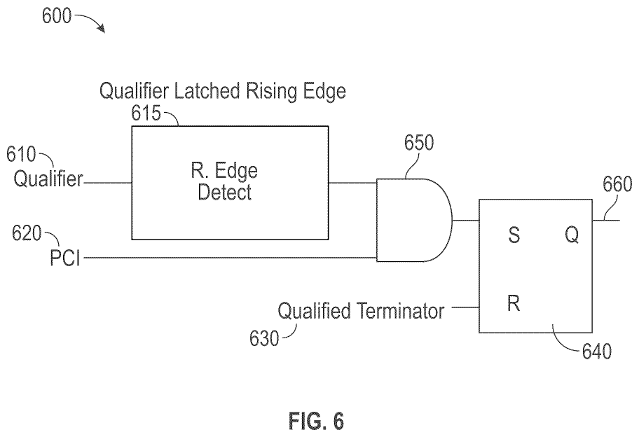

FIG. 6 illustrates one of various examples of a synchronizer circuit 600 for control of PWM signals. Qualifier 610 may be an input, and may be an inversion of an LEB signal. Qualifier 610 may be input to edge detector 615. Edge detector 615 may detect edge transitions in qualifier 610. The output of edge detector 615 may be coupled to a first input of AND gate 650. PCI input 620 may be input to a second input of AND gate 650. The output of AND gate 650 may be input to the set input of latch 640. Qualified terminator 630 may be coupled to the reset input of latch 640. Qualified terminator 630 may issue upon the expiration of the LEB period. In operation, while qualifier 610 is high, changes in PCI input 620 may be prevented from reaching output 660.

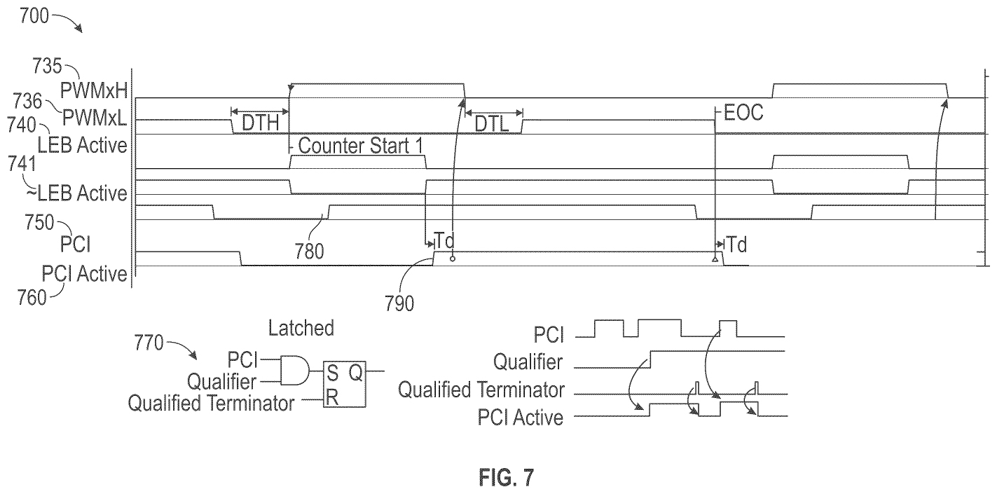

FIG. 7 illustrates another example of a waveform 700 and synchronizer circuit 770 for control of PWM signals. Trace 735 may represent a positive PWM signal and trace 736 may represent a complementary PWM signal. The example of FIG. 7 is illustrated with a differential PWM signal, but this is not intended to be limiting. Trace 740 may represent a LEB signal, and trace 741 may be an inversion of the LEB signal. Trace 750 may represent a PCI signal. The specific PCI may be a comparator signal or may be another control signal, including but not limited to a register configuration setting. The PCI input represented by trace 750 may comparator output 141 as described and illustrated in reference to FIG. 1. The PCI input may be coupled to the PCI input of synchronizer circuit 770. Synchronization circuit 770 may prevent transitions in trace 750 from affecting synchronizer output signal in 760 while trace 750 is high. As can be seen at location 780, the rising edge on trace 750 is prevented from affecting trace 760 until location 790, when trace 740 has reached a low signal level.

FIG. 7 depicts usage of PCI signals in a “latched” mode. The incoming PCI signal is qualified using a second signal. Once qualified, the PCI event is latched and remains active until a termination signal clears the latch. A new PWM cycle starts at the EOC event. In this case, the EOC event is used to reset the PCI latch and get ready for the next cycle. An LEB counter may be used to qualify the setting of the latch. This avoids responding to any comparator activity near the time the PWMH or PWML transitions, which can cause noise on the comparator output and an unwanted termination of the PWM signal via the PCI. When the LEB counter ends in 741, this serves as a qualifier for the setting of the PCI latch.

The PCI signal was already high in 750, but the PCI latch does not get set until 790 because of the LEB qualifier.

The PCI latch going high at 790 causes the PWMH signal to be driven low, ending the PWM pulse. The PCI latch remains set until EOC to avoid producing another PWM pulse within the same cycle.

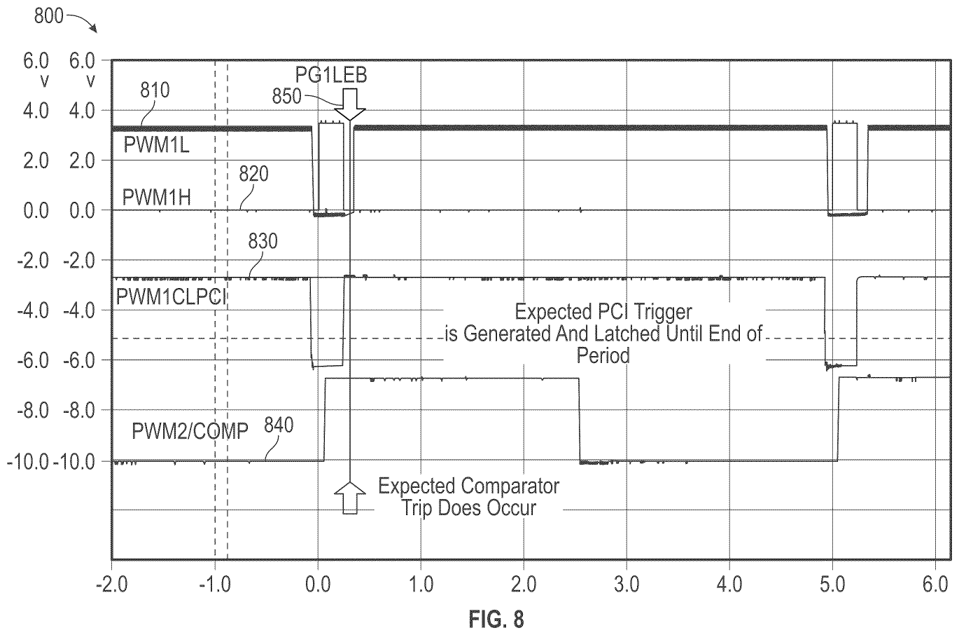

FIG. 8 illustrates one of various examples of a timing diagram 800 of PWM signals. Trace 810 may represent a negative PWM signal and trace 820 may represent a positive PWM signal. The example of FIG. 8 is illustrated with a differential PWM signal, but this is not intended to be limiting. Trace 840 may represent comparator output 141 as illustrated and described in reference to FIG. 1. The first rising edge of trace 840 may not affect trace 830, as the LEB signal is high until time 850, indicated by the arrow. At time 850, trace 830 does transition.

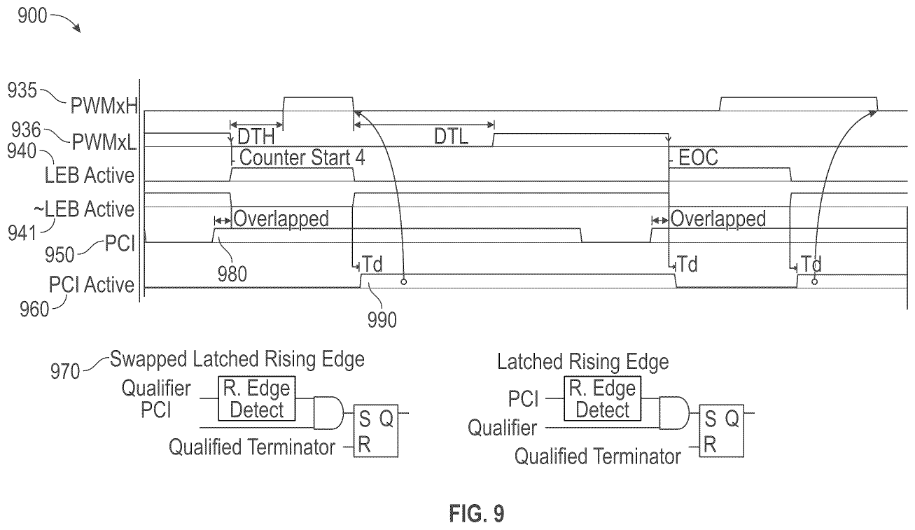

FIG. 9 illustrates another example of a waveform 900 and synchronizer circuit 970 for control of PWM signals. Trace 935 may represent a positive PWM signal and trace 936 may represent a negative PWM signal. The example of FIG. 9 is illustrated with a differential PWM signal, but this is not intended to be limiting. Trace 940 may represent a LEB signal, and trace 941 may be an inversion of the LEB signal. Trace 950 may represent a PCI signal. The specific PCI may be a comparator signal or may be another control signal, including but not limited to a register configuration setting. The PCI input represented by trace 950 may comparator output 141 as described and illustrated in reference to FIG. 1. The PCI input may be coupled to the PCI input of synchronizer circuit 970. Synchronization circuit 970 may prevent transitions in trace 950 from affecting synchronizer output signal in 960 while trace 950 is high. As can be seen at location 980, the rising edge on trace 950 may be prevented from affecting trace 960 until location 990, when trace 940 has reached a low signal level.

FIG. 9 depicts another mode of use of the PCI signal, using a rising edge event detect. (Latched Rising Edge mode). The LEB is connected to the input that is used in other examples as the qualifier, and vice versa. The inverted LEB signal is connected to the edge detect logic and the PCI is connected as the qualifier signal to the input AND gate.

The timing shown in FIG. 9 may be similar to the timing of FIG. 7, except that an edge event is to occur on the PCI qualifier signal while the PCI signal is high. In FIG. 7, the mode of operation is level sensitive, rather than a rising edge. The edge sensitivity operation of FIG. 9 allows the comparator signal in trace 950 to still be high when a new PWM cycle starts at EOC and not affect the PWM output until the rising edge of the inverted LEB signal 941.

In the above examples, comparator output 141 may be used as the PCI signal, and the PWM pulse may be programmed to end when a qualified PCI input is obtained. The difference modes shown allow user control over when the comparator signal ultimately takes effect and when the comparator action ends. While a comparator output may be used as a PCI input signal, as it might be used to monitor a current or a voltage, other signals may be used.

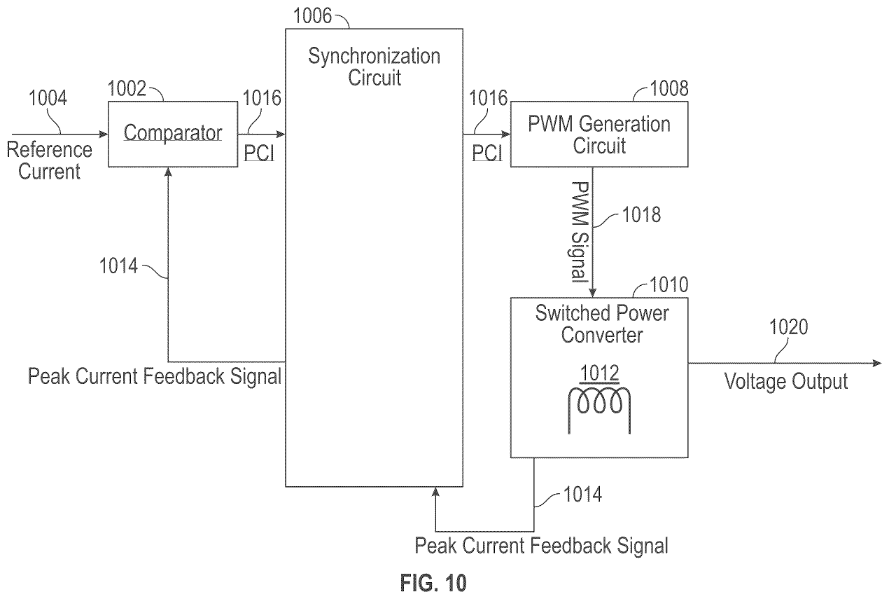

FIG. 10 is an illustration of a device 1000, according to examples of the present disclosure. Device 1000 may be another illustration of apparatus 100, or vice-versa. Device 1000 may include a switched power converter 1010 including an inductor 1012. The Switched power converter 1010 may be to produce a voltage output 1020 based on a PWM signal 1018 and produce a peak current feedback signal 1014, wherein peak current feedback signal 1014 is representative of a peak current through inductor 1012. Device 1000 may include a comparator 10002 to generate a PCI signal 1016 based on whether peak current feedback signal 1014 has reached a reference current 1004. Device 1000 may include a PWM generation circuit 1008 to generate PWM signal 1018 to control switching of switched power converter 1010 based on PCI signal 1016. Device 1000 may include a synchronization circuit 1006 to delay a change in PCI signal 1016.

Synchronization circuit 1006 may be implemented in a similar manner as or may be an implementation of synchronization circuit 102, or vice-versa. Switched power converter 1010 may be implemented in a similar manner as or may be an implementation of switched power converter 130 or vice-versa. Comparator 1002 may be implemented in a similar manner as or may be an implementation of comparator 140 or vice-versa. PWM generator circuit 1008 may be implemented in a similar manner as or may be an implementation of PWM generator circuit 128 or vice-versa.

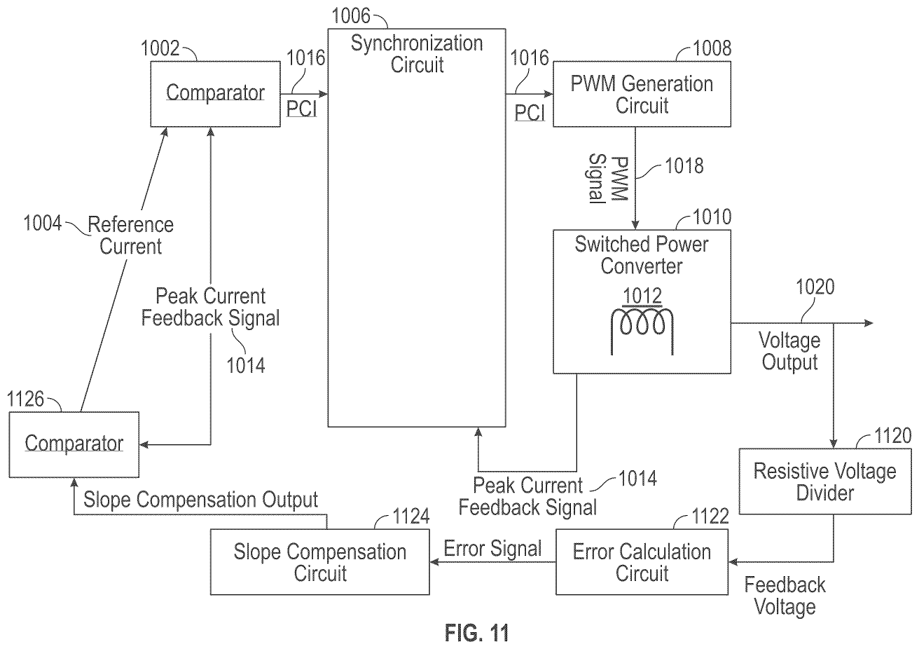

FIG. 11 is an illustration of a system 1100, according to examples of the present disclosure. System 1100 may be another illustration of apparatus 100, or vice-versa. Moreover, system 1100 may include an instance of device 1000.

System 1100 may include a resistive voltage divider 1120 coupled to the voltage output. Resistive voltage divider 1120 may produce a feedback voltage. Resistive voltage divider 1120 may be implemented in a similar manner as or may be an implementation of resistors 111, 112 of FIG. 1, or vice-versa.

System 1100 may include an error calculation circuit 1122 to receive the feedback voltage at an input and to output an error signal. Error calculation circuit 1122 may be implemented in a similar manner as or may be an implementation of feedback control circuit 145 of FIG. 1, or vice-versa.

System 1100 may include a slope compensation circuit 1124 to modify the error signal and to generate a slope compensation output. Slope compensation circuit 1124 may be implemented in a similar manner as or may be an implementation of slope compensation circuit 120 of FIG. 1, or vice-versa.

Comparator 1002 may generate the PCI signal 1016 based on whether the peak current feedback signal has reached a reference current indicated by output of first comparator 1126.

Synchronization circuit 1006 may delay or amend PCI 1016 from reaching PWM generation circuit 1008, or may delay or amend peak current feedback signal 1014 from reaching comparator 1002 so that PCI 1016 in turn might be delayed or amended.

Thus, in one example, synchronization circuit 1006 may delay a change in PCI 1016 through delay of a change in peak current feedback signal 1014 from reaching comparator 1002 to prevent comparator 1002 from changing PCI 1016 when peak current feedback signal 1014 has reached reference current 1004.

In another example, synchronization circuit 1006 may delay a change in PCI 1016 as-issued by comparator 1002 from reaching PWM generation circuit 1008 when peak current feedback signal 1014 has reached reference current 1004.

As shown in FIGS. 6, 7, 9, synchronization circuit 1006 may include a latch to maintain PCI 1016 based on a LEB signal. As shown in FIGS. 5, 7, 9, the LEB signal may mask PCI 1016 for a period of time when a PWM signal transitions. As shown in FIGS. 5-9, synchronization circuit 1006 may detect a PWM output transition, begin counting an LEB period based upon the PWM output transition, hold the PCI signal constant during the LEB period, and allow the PCI signal to transition after the LEB period. As shown in FIGS. 6, 7, 9, the latch may be reset at the end of the LEB period.

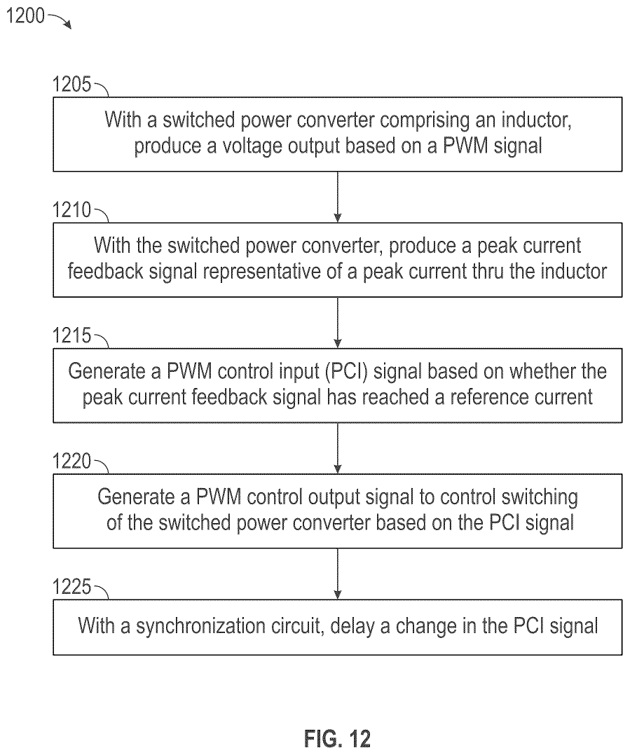

FIG. 12 is an illustration of an example method 1200 for feedback control in switched converters, according to examples of the present disclosure. Method 1200 may include more or fewer steps than shown in FIG. 12. Various steps of method 1200 may be optionally repeated, omitted, performed in parallel, or performed recursively.

At 1205, with a switched power converter including an inductor, voltage output based on a PWM signal may be produced.

At 1210, a peak current feedback signal may be produced. The peak current feedback signal may be representative of a peak current through the inductor.

At 1215, a PCI signal may be generated based on whether the peak current feedback signal has reached a reference current.

At 1220, with a synchronization circuit, a change in the PCI signal may be delayed.

The change in the PCI signal may be delayed by delaying a change in the peak current feedback signal from reaching a component that generates the PCI signal, in which case 1220 may occur before 1215. Thus, delaying the change in the PCI signal may be performed through delay of a change in the peak current feedback signal from being used to change the PCI signal when the current feedback signal has reached the reference current.

The change in the PCI signal may be delayed by delaying the PCI signal itself. Thus, the change may be delayed by delaying the change in the PCI signal from reaching a PWM generation circuit when the current feedback signal has reached the reference current.

Delaying the change in the PCI signal may be performed with a latch to maintain the PCI signal based on a LEB signal.

Delaying the change in the PCI signal may be performed by use of the LEB signal to mask the PCI signal for a period of time when the PWM signal transitions.

Delaying the change in the PCI signal may include detecting a PWM output transition, beginning counting a LEB period based upon the PWM output transition, holding the PCI signal constant during the LEB period, and allowing the PCI signal to transition after the LEB period.

At 1225, the PWM signal may be generated to control switching of the switched power converter based on the PCI signal.

What is claimed is:

1. An apparatus, comprising:
a switched power converter comprising an inductor, the switched power converter to:
produce a voltage output based on a pulse-width modulated (PWM) signal; and
produce a peak current feedback signal, the peak current feedback signal representative of a peak current through the inductor;
a comparator to generate a PWM control input (PCI) signal based on whether the peak current feedback signal has reached a reference current;
a PWM generation circuit to generate the PWM signal to control switching of the switched power converter based on the PCI signal; and
a synchronization circuit to delay a change in the PCI signal.

2. The apparatus as claimed in claim 1, wherein the synchronization circuit is to delay the change in the PCI signal through delay of a change in the peak current feedback signal from reaching the comparator to prevent the comparator from changing the PCI signal when the peak current feedback signal has reached the reference current.

3. The apparatus as claimed in claim 1, wherein the synchronization circuit is to delay a change in the PCI signal issued by the comparator from reaching the PWM generation circuit when the current feedback signal has reached the reference current.

4. The apparatus as claimed in claim 1, wherein the synchronization circuit comprises a latch to maintain the PCI signal based on a leading edge blanking (LEB) signal.

5. The apparatus as claimed in claim 4, wherein the LEB signal is to mask the PCI signal for a period of time when the PWM signal transitions.

6. The apparatus as claimed in claim 5, wherein:
the synchronization circuit is to detect a PWM output transition;
based upon the PWM output transition, begin counting a LEB period;
during the LEB period, hold the PCI signal constant; and
after the LEB period, allow the PCI signal to transition.

7. The apparatus as claimed in claim 6, wherein the latch is reset at a termination of the LEB period.

8. A system comprising:
a switched power converter comprising an inductor, the switched power converter to:
produce a voltage output based on a pulse-width modulated (PWM) signal; and
produce a peak current feedback signal, the peak current feedback signal representative of a peak current through the inductor;
a resistive voltage divider coupled to the voltage output, the resistive voltage divider to produce a feedback voltage;
an error calculation circuit to receive the feedback voltage at an input and to output an error signal;
a slope compensation circuit, the slope compensation circuit to modify the error signal and to generate a slope compensation output;
a comparator to generate a PWM control input (PCI) signal based on whether the peak current feedback signal has reached a reference current indicated by the slope compensation output;
a PWM generation circuit to generate the PWM signal to control switching of the switched power converter based on the PCI signal; and
a synchronization circuit to delay a change in the PCI signal.

9. The system as claimed in claim 8, wherein the synchronization circuit is to delay the change in the PCI signal through delay of a change in the peak current feedback signal from reaching the comparator to prevent the comparator from changing the PCI signal when the current feedback signal has reached the reference current.

10. The system as claimed in claim 8, wherein the synchronization circuit is to delay a change in the PCI signal issued by the comparator from reaching the PWM generation circuit when the peak current feedback signal has reached the reference current.

11. The system as claimed in claim 8, wherein the synchronization circuit comprises a latch to maintain the PCI signal based on a leading edge blanking (LEB) signal.

12. The system as claimed in claim 11, wherein the LEB signal is to mask the PCI signal for a period of time when PWM signal transitions.

13. The system as claimed in claim 12, wherein:
the synchronization circuit is to detect a PWM output transition;
based upon the PWM output transition, begin counting a LEB period;
during the LEB period, hold the PCI signal constant; and
after the LEB period, allow the PCI signal to transition.

14. The system as claimed in claim 13, wherein the latch is reset at a termination of the LEB period.

15. A method, comprising:
with a switched power converter, the switched power converter comprising an inductor:
producing a voltage output based on a pulse-width modulated (PWM) signal; and
producing a peak current feedback signal, the peak current feedback signal representative of a peak current through the inductor;
generating a PWM control input (PCI) signal based on whether the peak current feedback signal has reached a reference current;
generating the PWM signal to control switching of the switched power converter based on the PCI signal; and
with a synchronization circuit, delaying a change in the PCI signal.

16. The method of claim 15, comprising delaying the change in the PCI signal through delay of a change in the peak current feedback signal from being used to change the PCI signal when the current feedback signal has reached the reference current.

17. The method of claim 15, comprising delaying the change in the PCI signal from reaching a PWM generation circuit when the peak current feedback signal has reached the reference current.

18. The method of claim 15, comprising delaying the change in the PCI signal with a latch to maintain the PCI signal based on a leading edge blanking (LEB) signal.

19. The method of claim 18, comprising using the LEB signal to mask the PCI signal for a period of time when the PWM signal transitions.

20. The method of claim 19, comprising:
detecting a PWM output transition;
based upon the PWM output transition, beginning counting a LEB period;
during the LEB period, holding the PCI signal constant; and
after the LEB period, allowing the PCI signal to transition.
